(19) United States
(12) Patent Application Publication
(10) Pub. No.: US 2003/0009487 A1
(43) Pub. Date: Jan. 9, 2003

(54) Policy implementation

(76) Inventors: Senthil Prabakaran, Norwood, MA (US); Daniel Kim, Woodland Hills, CA (US); Kul B. Sharma, Lowell, MA (US)

Correspondence Address: KENNETH F. KOZIK, Fish & Richardson P.C., 225 Franklin Street, Boston, MA, 02110-2804, US

(21) Appl. No.: 10/057,249

(22) Filed: Jan. 25, 2002

Related U.S. Application Data
(60) Provisional application No. 60/264,414, filed on Jan. 26, 2001.

(51) Int. Cl. G06F 12/00

(52) U.S. Cl. 707/204

(57) ABSTRACT

A method for implementing policies for nodes connected to a network having a policy manager that determines the specific policy the node should receive, and a data source for the storage of policies comprising providing for the request of a policy from the node to the policy manager, providing for the determination of the particular provider needed to facilitate transfer of the requested policy from the data source, providing for the transfer of a resultant list of policies from the particular data source, providing for the modification of the list of policies in accordance with a dynamic set of policy rules, providing for the retrieval of the policy settings associated with the policies in the modified list, providing for the transfer of the policy attributes to the particular node making the request and providing for the implementation of the policy attributes on the particular node making the request.

### TECHNICAL FIELD

This invention relates to policy implementation.

### BACKGROUND

Policies are a set of enforceable parameters that control the operation and functionality of personal computers and peripheral hardware devices used by the personal computer (e.g., printers). Policies are utilized in both distributed computing environments (e.g., local area networks or wide area networks) and stand-alone personal computers. In a distributed computing environment policies are created and stored in a central computer (e.g., a server computer) and downloaded to the individual personal computers linked to the network (e.g., workstation computers) each time a user logs on to the network. In a standalone personal computer, policies are created and stored locally on the personal computer.

### SUMMARY

In an aspect, the invention features a method for providing a network. The network has a first system that generates a request of a policy from the first system to a second system. The second system determines the policy for the first system and provides the policy to the first system.

One or more of the following features may also be included. The first system can be a desktop or laptop computer, handheld computer, mobile or desk telephone, personal data assistant, server appliance, numeric or alphanumeric pager, set-top box, air conditioning units, heating units, lights. The second system may be the same as the first or it may be different. The policy managers may be software applications. The data sources may be server-type computers associated with a local-area or wide-area network. The creation and storage of a policy can be facilitated on a separate computer using a plurality of software applications designed to create policies. All information transfer between the nodes and the policy manager may be done with a markup computer language such as Extensible Markup Language (XML), Directory Services Markup Language (DSML), Simple Object Access Protocol (SOAP), and so forth. The determination of the particular provider needed may be done using a lookup table based on the policy parameters. The implementation of the policy settings on the particular node requesting said policy may be done in a hierarchical format.

Embodiments of the invention may have one or more of the following advantages.

The technique provides for the management and implementation of computer policies that are applicable to all computers on a heterogeneous network utilizing a plurality of operating systems.

The technique provides a multi-tiered architecture that separates the client from the business logic of policy determination and the specific policy formats and management at the server level.

The technique provides an architecture for implementation of policies on devices that do not have operating systems, i.e., the use of an independent node proxy as part of the multi-tier policy architecture capable of interfacing with non-operating system devices.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an illustration of a three-tier architecture for implementing policies in a network.

FIG. 2 is an illustration of a computer system of a first tier of the three-tier architecture.

FIG. 3 is an illustration of a server system.

FIG. 4 is an illustration of a second server system.

FIG. 5 is an illustration of a first tier of the three-tier architecture.

FIG. 6 is an illustration of a second tier of the three-tier architecture.

FIG. 7 is an illustration of a third tier of the three-tier architecture.

FIG. 8 is an illustration of the steps for implementing policies on a server utilizing the three-tier architecture.

Like reference symbols in the various drawings indicate like elements.

### DETAILED DESCRIPTION

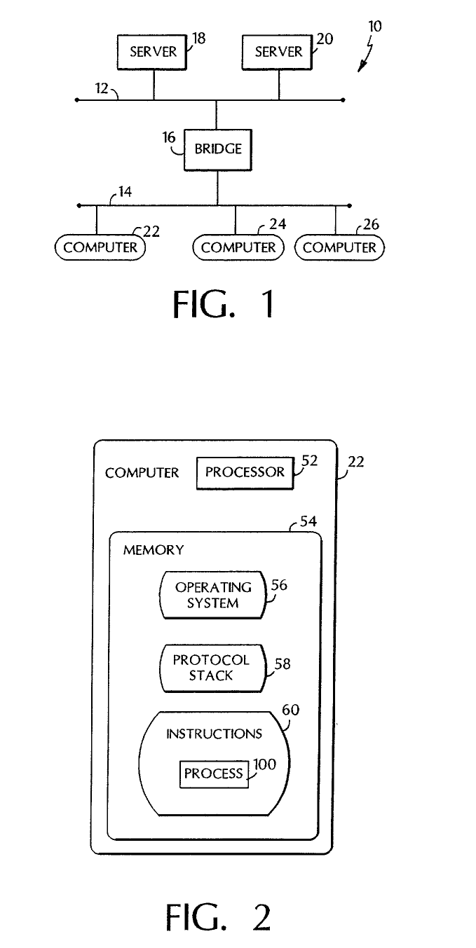

Referring to FIG. 1, an exemplary network 10 includes a local area network (LAN) 12 and a local area network (LAN) 14 linked via a bridge 16. The LAN 12 includes sever systems 18, 20. The LAN 14 includes computer systems 22, 24 and 26.

Referring to FIG. 2, each computer system, computer systems 22 for example, includes a processor 52 and a memory 54, memory 54 stores an operating system (o/s) 56 such as Microsoft Windows 2000, UNIX or LINNX, a TCP/IP protocol stack 58, and machine-executable instructions 60 executed by processor 52 so to perform a client tier policy process 100, described below.

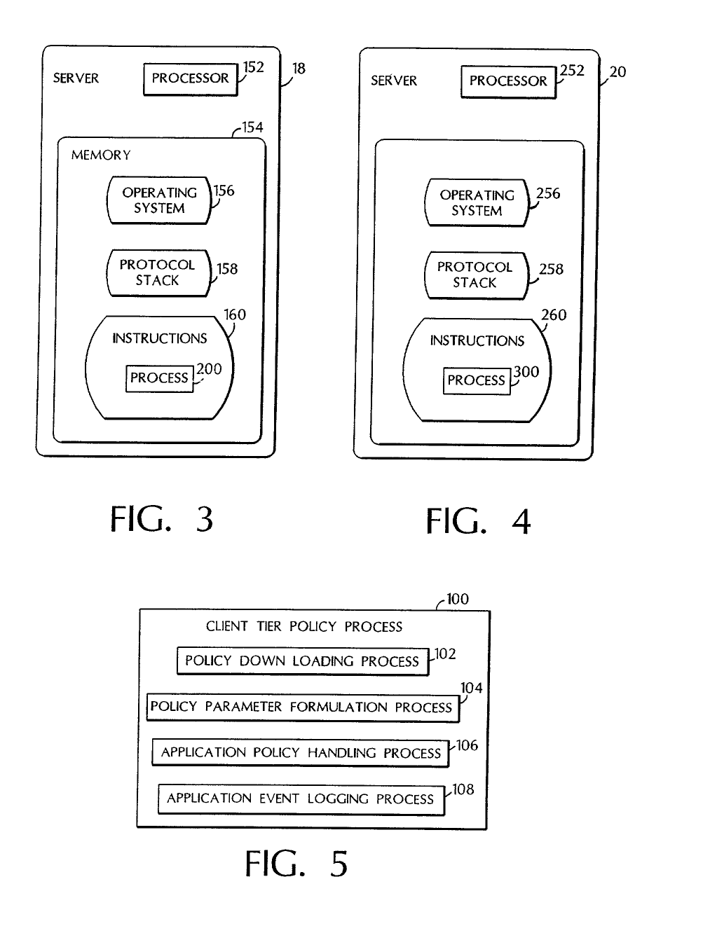

Referring to FIG. 3, a first selected server system, such as server system 18, includes a processor 152 and memory 154. Memory 154 stores an o/s 156, a TCP/IP protocol stack 158 and machine-executable instructions 160 executed by processor 152 to perform on intermediate tier policy process 200 described below.

Referring to FIG. 4, a second selects server system, such as server system 20, includes a processor 252 and memory 254, memory 254 stores an O/S 256, TCP/IP protocol stack 258 and machine-executable instruction 260 executed by processor 252 to perform a server tier policy process 300 described below.

Referring to FIG. 5, the client tier policy process 100 includes a policy downloading process 102, a policy parameter formulation process 104, and application policy handling process 106 and an application event logging process 108.

The policy downloading process 102 generates a request for download of polices to the server system 16. Events external to process 100, such as user logon, computer 50 restart, scheduled download or request for manual refresh of policies triggers the policy downloading process 102. The policy downloading process 102 interfaces with the policy parameter formulation process 104.

The policy parameter formulation process 104 calls for each object in the client system 16 that needs to be configured through policies and retrieves state information resident on the server system 16. In an example, the policy parameter formulator process 104 retrieves state information not specific to a single type of system. Upon retrieving the state information, the policy parameter formulator process 104 packages the state information into a generic markup language format, such as Extensible Markup Language (XML) format, and sends the packaged information as a request for a policy to a “middle tier system,” such as server 116.

XML is a flexible way to generate common information formats and share both the format and the data on the World Wide Web, intranets, and elsewhere. For example, computer makers might agree on a standard or common way to describe the information about a computer product (processor speed, memory size, and so forth) and then describe the product information format with XML. Such a standard way of describing data enables a user to send an intelligent agent (a program) to each computer maker's Web site, gather data, and then make a valid comparison. XML can be used by any individual or group of individuals or companies that want to share information in a consistent way. XML is similar to the language of today's Web pages, the Hypertext Markup Language (HTML). Both XML and HTML contain markup symbols to describe the contents of a page or file. HTML, however, describes the content of a Web page (mainly text and graphic images) only in terms of how it is to be displayed and interacted with. For example, the letter “p” placed within markup tags starts a new paragraph. XML describes the content in terms of what data is being described. For example, the word “phonenum” placed within markup tags could indicate that the data that followed was a phone number. This means that an XML file can be processed purely as data by a program or it can be stored with similar data on another computer or, like an HTML file, that it can be displayed. For example, depending on how the application in the receiving computer wanted to handle the phone number, it could be stored, displayed, or dialed. XML is “extensible” because, unlike HTML, the markup symbols are unlimited and self-defining. XML is actually a simpler and easier-to-use subset of the Standard Generalized Markup Language (SGML), the standard for how to create a document structure.

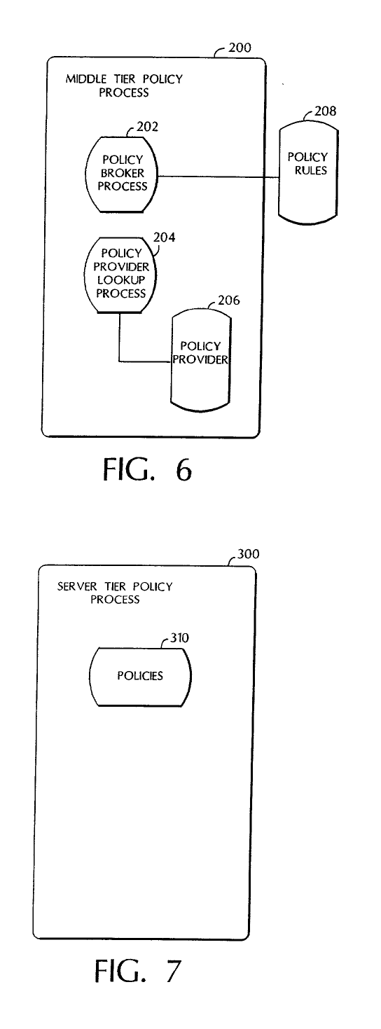

Referring to FIG. 6, the middle tier policy process 200 includes a policy broker process 202 and a policy provider lookup process 204. The Policy Broker process 202 is coupled to policy rules 208 resident in memory 154 and the policy provider lookup process 204 is coupled to the policy provider process 206.

Referring to FIG. 7, the server tier policy process 300 stores policies 310 facilitated by the middle tier policy process 200 from the client tier policy process 100.

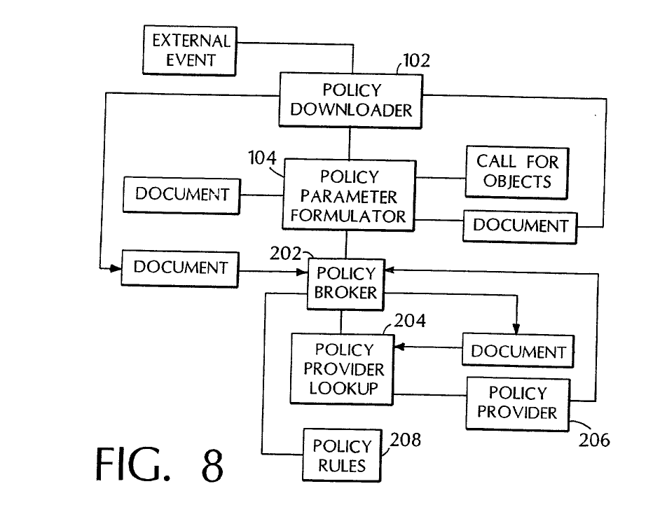

Referring to FIG. 8, the client tier policy process 100 comprises various software components that reside either on a node or node proxy. The Policy Downloader 102 initiates the download of policies. External events such as user logon, machine restart, scheduled download or request for manual refresh of policies triggers the download process. The Policy Parameter Formulator 104 calls for each object that needs to be configured through policies (node) and retrieves the client state information. In an alternative form, the Policy Parameter Formulator 104 could retrieve information not specific to a single type of node. Upon retrieving the information, the Policy Parameter Formulator 104 packages the information into a generic XML format. The Policy Parameter Formulator 104 sends the packaged information as a request for a policy to the Policy Broker process 202. The Application Policy Handler 106 reads the final policy contents returned from the Policy Broker process 202 and modifies the configuration of the node. The Application Policy Handler 106 logs all the messages during the process of the policy content to the Application Event Server either directly or through an Application Event Logger 108.

The Policy Broker process 202 is a middle ware agent that coordinates all communication between the Client and the Data Source and between the different server components. The Policy Broker process 202 gets the request for policies from the Policy Downloader 102 as an XML document of policy parameters. The Policy Broker process 202 then calls the Policy Provider Lookup component 204 and passes the policy parameters. The Policy Provider Lookup component 204 chooses the applicable particular Policy Provider 206 by examining the policy parameters. The Policy Providers 206 are the primary abstraction component to interface with the Directory Service. If there are more than one directory services, each directory service has a corresponding Policy Provider 206. The Policy Providers 206 each have a unique identification code that is registered with the Policy Provider Lookup Component 204. The Policy Provider Lookup Component 204 passes the chosen Policy Provider's 206 unique identification code back to the Policy Broker process 202. The Policy Broker process 202 then invokes a series of Policy Rules 208 that has been registered with it. The Policy Rules Component 208 then modifies the list of policies based on the Policy Parameters or on other custom parameters. The modified list is chained though all the Policy Rules components and returned to the Policy Broker process 202. After receiving the modified list of policies, the Policy Broker process 202 invokes the Policy Provider 206 and retrieves the content of the individual policies. The Policy Provider 206 converts the native policy storage into an XML format. The Policy Broker process 202 returns the content of the policies back to the Policy Downloader 102.

What is claimed is:

1. A method comprising:
providing a network, the network having a first system;
generating a request of a policy from the first system to a second system;
retrieving the policy for the first system in the second system; and
providing the policy to the first system.

2. The method of claim 1 further comprising a third system for determining the policy the first system should receive.

3. The method of claim 1 in which the second system designates the parameters of the policy.

4. The method of claim 1 further comprising a third system for receiving the policy from the second system.

5. The method of claim 1 wherein the first system is a policy enabled node.

6. The method of claim 5 wherein the policy enabled node is enabled by a node proxy.

7. The method of claim 1 wherein the policy parameters are unique to the request.

8. The method of claim 1 wherein the node is a computer.

9. The method of claim 1 wherein the independent node is a software application.

10. The method of claim 1 wherein a provider facilitates transfer of the policy from a data source.

11. A method comprising:
a policy implementation;
generating a policy file;
having a first system; and
providing a second system to download the policy file for the first system.

12. The method of claim 11 having the same operating system for the first system and the second system.

13. The method of claim 11 having a different operating system for the first system and the second system.

14. A method comprising:
receiving a policy request from a first system;
processing the policy request in a second system;
retrieving a policy for the first system;
processing a final policy content from the policy; and
sending the final policy content to the first system.

15. The method of claim 14 having the same operating system for the first system and the second system.

16. The method of claim 14 having a different operating system for the first system and the second system.

17. The method of claim 1 further comprising a policy parameter wherein the policy parameter calls for each object.

18. The method of claim 11 further comprising a policy parameter wherein the policy parameter calls for each object.

19. The method of claim 14 further comprising a policy parameter wherein the policy parameter calls for each object.

20. The method of claim 1 wherein the first system uses Extensible Markup Language (XML), Directory Services Markup Language (DSML), or Simple Object Access Protocol (SOAP).

21. The method of claim 11 wherein the first system uses Extensible Markup Language (XML), Directory Services Markup Language (DSML), or Simple Object Access Protocol (SOAP).

22. The method of claim 14 wherein the first system uses Extensible Markup Language (XML), Directory Services Markup Language (DSML), or Simple Object Access Protocol (SOAP).

23. A method for implementing policies for the administration of nodes connected to a network having at least, a single node or plurality of nodes to be policy enabled, one or more policy managers that determine the specific policy the node(s) should receive, and one or more data sources for the storage of policies, said method comprising the steps of:
providing for the request of a policy from the node or node proxy to the policy manager, with the specific policy parameters for the particular node making the request;
providing for the determination of the particular provider needed to facilitate transfer of the requested policy from the data source;
providing for the transfer of a resultant list of policies from the particular data source based on the policy parameters;
providing for the modification of the list of policies in accordance with a dynamic set of policy rules;
providing for the retrieval of the policy settings associated with the policies in the modified list;
providing for the transfer of the policy attributes to the particular node making the request; and
providing for the implementation of the policy attributes on the particular node making the request.
